(19) United States
(12) Patent Application Publication
(10) Pub. No.: US 2012/0237824 A1
(43) Pub. Date: Sep. 20, 2012

(54) POSITIVE ELECTRODE CURRENT COLLECTOR LAMINATE FOR LITHIUM SECONDARY BATTERY

(75) Inventors: Meiten Koh, Settsu-shi (JP); Hideo Sakata, Settsu-shi (JP); Hiroyuki Arima, Settsu-shi (JP); Tomoyo Sanagi, Settsu-shi (JP)

(73) Assignee: Daikin Industries, Ltd., Osaka-shi, Osaka (JP)

(21) Appl. No.: 13/497,900

(22) PCT Filed: Sep. 22, 2010
(86) PCT No.: PCT/JP2010/066370

§ 371 Date: Mar. 23, 2012

(30) Foreign Application Priority Data
Sep. 25, 2009 (JP) 2009-221336

(51) Int. Cl. H01M 4/66

(52) U.S. Cl. 429/211

(57) ABSTRACT

The present invention provides a positive electrode current collector laminate that has the ability, even in the case of high voltage operation, to protect a positive electrode current collector from corrosion without impairing the battery characteristics, and also provides a lithium secondary battery. The positive electrode current collector laminate has an electroconductive protective layer (B) that contains a fluororesin (b1) and an electroconductive filler (b2) and is disposed on a positive electrode current collector (A), and the lithium secondary battery uses this positive electrode current collector laminate.

### TECHNICAL FIELD

The present invention relates to a positive electrode current collector laminate for a lithium secondary battery, to a positive electrode laminate and to a lithium secondary battery.

### BACKGROUND ART

A lithium secondary battery is provided with: a positive electrode in which a positive electrode mixture layer containing a positive electrode active material such as a lithium-containing composite oxide is disposed on a positive electrode current collector such as aluminum foil; a negative electrode in which a negative electrode mixture layer containing a negative electrode active material such as a carbonaceous material is disposed on a negative electrode current collector such as aluminum foil; and a nonaqueous electrolyte solution containing an organic solvent and an electrolyte salt such as a lithium salt.

The positive electrode current collector in a lithium secondary battery with the above-described structure undergoes corrosion by anodic oxidation due to the action of the electrolyte, e.g., a lithium salt, that is present in the electrolyte solution. Accordingly, such a lithium secondary battery has a low battery capacity and low cycle characteristics.

In order to prevent or inhibit this corrosion of the positive electrode current collector, Patent Reference 1 proposes the formation on the current collector of a surface protective layer that contains a heterocyclic compound, e.g., a triazole or a coumarin, while Patent Reference 2 describes the use of an epoxy resin as a binder. Patent Reference 2 also proposes the formation on the current collector of a protective layer that contains at least one material selected from the noble metals, alloys, electroconductive ceramics, semiconductors, organic semiconductors, and electroconductive polymers, and provides polyaniline, polypyrrole, polyacene, polydisulfide, and poly(p-phenylene) as examples of the electroconductive polymer. In an example of a method for forming the protective layer using an electroconductive polymer, Patent Reference 2 describes preparing a mixed solution by dissolving an electroconductive polymer, a binder, and a dopant (aromatic sulfonic acid ester) in a solvent; casting or applying this mixed solution; and heating and drying.

Patent Reference 3, while being an invention that relates to a negative electrode current collector, proposes polyvinylidene fluoride, polyacrylic acid, and polypropylene as binders for an electroconductive protective film formed on a negative electrode current collector.

Patent Reference 1: Japanese Patent Application Laid-open No. H10-162833

Patent Reference 2: Japanese Patent Application Laid-open No. 2002-203562

Patent Reference 3: Japanese Patent Application Laid-open No. 2008-117574

### DISCLOSURE OF THE INVENTION

However, the properties required of batteries have become quite severe in recent years, and there is also demand for even higher voltages (for example, 4.35 V and above). Corrosion of the positive electrode current collector is promoted by high voltage operation, and protection of the positive electrode current collector during high voltage operations is thus a critical issue.

In addition, since wound-electrode configurations (wound or spiral type) are the predominant configuration for small, high-capacity lithium secondary batteries, high flexibility is thus required of the electrodes.

Viewed in these terms, the heterocyclic compound surface protective layer described in Patent Reference 1 is unsatisfactory from the standpoint of the oxidation potential. In addition, the materials described in Patent References 2 and 3 cause the electrode to become hard and to have a deficient flexibility. Moreover, the material described in Patent Reference 3, while being effective from the standpoint of preventing the corrosion of aluminum foil, is unsatisfactory when used at high voltages.

An object of the present invention is to provide a positive electrode current collector laminate that has the ability, even in the case of high voltage operation, to protect a positive electrode current collector from corrosion without impairing the battery characteristics, and to also provide a lithium secondary battery.

The present invention relates to a positive electrode current collector laminate in which an electroconductive protective layer (B) containing a fluororesin (b1) and an electroconductive filler (b2) is disposed on a positive electrode current collector (A).

The present invention also relates to a positive electrode laminate in which a positive electrode mixture layer (C) is disposed on an electroconductive protective layer (B) of the positive electrode current collector laminate according to the present invention and further relates to a lithium secondary battery provided with a positive electrode, a negative electrode, and a nonaqueous electrolyte solution wherein the positive electrode is the positive electrode current collector laminate according to the present invention.

The present invention can provide a positive electrode current collector laminate that has the ability, even in the case of high voltage operation, to protect a positive electrode current collector from corrosion without impairing the battery characteristics, and can also provide a lithium secondary battery.

### BRIEF DESCRIPTION OF THE DRAWINGS

FIG. 1 is a schematic structural diagram in perspective view of the laminate cell fabricated in Examples 25 to 27; and

FIG. 2 is a schematic plan diagram of the laminate cell fabricated in Examples 25 to 27.

### MODES FOR CARRYING OUT THE INVENTION

The positive electrode current collector laminate of the present invention has an electroconductive protective layer (B) containing a fluororesin (b1) and an electroconductive filler (b2) disposed on a positive electrode current collector (A).

Each of these structures is described herebelow.

(A) The Positive Electrode Current Collector

The material used for the positive electrode current collector can be exemplified by aluminum and its alloys, stainless steel, nickel and its alloys, titanium and its alloys, and materials provided by treating the surface of aluminum or stainless steel with carbon or titanium. Among the preceding, aluminum and aluminum alloys are examples of positive electrode current collectors to be protected in particular. These materials may also be used after oxidation of the surface. The introduction of peaks and valleys into the surface of the current collector by a surface treatment is preferred since this improves the adhesiveness. The thickness of the positive electrode current collector is generally in the range from 5 to 30 μm.

(B) The Electroconductive Protective Layer

An electroconductive protective layer (B) containing a fluororesin (b1) and an electroconductive filler (b2) is disposed on the current collector (A) in the positive electrode current collector laminate of the present invention.

Each of these components is described herebelow.

(b1) The Fluororesin

Any fluororesins not susceptible to oxidation can be used without particular limitation as the fluororesin (b1), and examples thereof include a fluororesin (VdF-type resin) that contains a structural unit derived from vinylidene fluoride (VdF), an acrylate/methacrylate that contains the fluorine atom in side chain position, a copolymer of tetrafluoroethylene (TFE) and a hydrocarbon-type vinyl ether/vinyl ester. Preferred thereamong are VdF-type resins for their ease of incorporation of electroconductive fillers, their excellent oxidation resistance, and the ease with which they maintain their flexibility.

The VdF-type resins can be exemplified by polyvinylidene fluoride (PVdF), which is a homopolymer of VdF, and copolymers of VdF with other fluorinated monomer and/or with a fluorine-free monomer.

The other fluorinated monomer can be exemplified by fluorine-containing monomers such as TFE, hexafluoropropylene (HFP), fluoroalkyl vinyl ethers, perfluoro(alkyl vinyl ether) (PAVE), chlorotrifluoroethylene (CTFE), trifluoroethylene, trifluoropropylene, tetrafluoropropylene, pentafluoropropylene, trifluorobutene, tetrafluoroisobutene, vinyl fluoride, iodine-containing fluorinated vinyl ethers, and so forth. The fluorine-free monomer can be exemplified by ethylene (Et), propylene (Pr), alkyl vinyl ethers, and so forth. A single selection from these fluorinated monomers and fluorine-free monomers or a combination of two or more selections from these fluorinated monomers and fluorine-free monomers can be used.

At least one selection from PVdF, TFE/VdF copolymers, TFE/VdF/HFP copolymers, and VdF/HFP copolymers is preferred among the preceding from the perspective of obtaining an excellent flexibility and an excellent oxidation resistance. Copolymers containing TFE and VdF are preferred thereamong due to their low swellability in electrolyte solutions.

(b2) The Electroconductive Filler

The electroconductive filler (b2) used in the present invention denotes a filler having a volume resistivity of from 1×10⁻⁹ to 1 Ω.cm. The preferred volume resistivity is 1×10⁻⁸ to 1×10⁻¹ Ω.cm.

The electroconductive filler (b2) can be exemplified by electroconductive carbon fillers.

These electroconductive fillers may be a particulate filler, a fibrous filler, or a combination thereof.

Particulate carbon fillers can be exemplified by Ketjenblack, acetylene black, nanoporous carbon, graphite (natural graphite, artificial graphite), furnace black, and channel black, whereamong nanoporous carbon and graphite are preferred for their good chemical resistance and electroconductivity and because they also provide an excellent composition fluidity, while Ketjenblack and acetylene black are preferred for their excellent chemical resistance and electroconductivity. An average primary particle diameter of 0.002 to 20 μm and particularly 0.025 to 10 μm is desirable from the standpoint of obtaining an excellent electroconductivity.

The fibrous carbon filler can be exemplified by carbon fiber, carbon nanotube, carbon nanofiber, and so forth, whereamong carbon nanotube and carbon nanofiber are preferred from the standpoint of obtaining an excellent electroconductivity and carbon fiber is preferred from the standpoint of obtaining an excellent cost performance. The diameter of the fibrous carbon is preferably not more than 20 μm and is more preferably 0.1 to 16 μm and particularly preferably 1 to 15 μm for the excellent electroconductivity this provides. In addition, the average fiber length/average fiber diameter ratio is preferably at least 5 and more preferably at least 10 for the excellent electroconductivity this provides. It is preferably not more than 1000 and more preferably not more than 500 from the standpoint of the ease of composition production.

Among the preceding, the incorporated filler is preferably at least one filler selected from the group consisting of Ketjenblack, acetylene black, nanoporous carbon, graphite, carbon fiber, carbon nanotube, and carbon nanofiber.

A particulate carbon filler may be used in combination with a fibrous carbon filler. This co-use provides, for example, for an even more facile control of the aspect ratio of the electroconductivity of the protective layer, described below, and also provides additional improvements in the electroconductivity of the protective layer as compared to use of only a single type. With regard to the particulate carbon filler/fibrous carbon filler mixing proportion, the particulate carbon filler is preferably at least 10 mass % and more preferably at least 20 mass % because this provides the composition with an excellent fluidity. In addition, it is preferably not more than 90 mass % and more preferably not more than 80 mass % from the standpoint of ease of control of the aspect ratio of the electroconductivity in the protective layer.

The quantity of incorporation for the electroconductive filler (b2) is from 5 to 300 mass parts per 100 mass parts of the fluororesin (b1). The electroconductivity of the protective layer is unsatisfactory at less than 5 mass parts. On the other hand, production of the composition is problematic at above 300 mass parts. The preferred lower limit is 5 mass parts from the standpoint of obtaining an excellent electroconductivity for the protective layer. The preferred upper limit is 200 mass parts from the standpoint of obtaining an excellent stability during molding and more preferred upper limit is 100 mass parts for the ease of composition preparation this provides. An electroconductive carbon filler may be used in combination with a metal filler within the indicated range. Such a combination will be a particulate carbon filler plus a particulate and/or a fibrous metal filler or will be a fibrous carbon filler plus a particulate and/or a fibrous metal filler, and a suitable selection therefrom is made in conformity with the property requirements. The mixing ratio may also be selected as appropriate considering, for example, the weight and electroconductivity of each filler and the elasticity and flexibility of the produced electroconductive protective layer.

A non-electroconductive filler (volume resistivity in excess of 1 Ω.cm) may also be used in addition to the electroconductive filler (b2) or in place of a portion of the electroconductive filler (b2). This non-electroconductive filler can be exemplified by non-electroconductive carbon fillers, non-electroconductive inorganic oxide fillers, and non-electroconductive resin fillers. The non-electroconductive carbon fillers can be specifically exemplified by non-electroconductive carbon blacks, non-electroconductive Austin black, non-electroconductive graphite (natural graphite, artificial graphite), non-electroconductive carbon nanotube, and non-electroconductive graphitized carbon black; the non-electroconductive inorganic oxide fillers can be specifically exemplified by silica, silicate, clay, diatomaceous earth, montmorillonite, talc, calcium carbonate, calcium silicate, barium sulfate, fatty acid calcium salts, titanium oxide, red iron oxide, boron nitride, aluminum nitride, magnesium oxide, and alumina; and the non-electroconductive resin fillers can be specifically exemplified by polyethylene, heat-resistant engineering plastics, fluoropolymers such as polyvinylidene fluoride (PVdF) and PTFE-based ethylene-tetrafluoroethylene copolymer (ETFE) produced from tetrafluoroethylene and ethylene, and polyimide. The quantity of incorporation may be selected as appropriate based on such considerations as the effects provided by incorporation, the electroconductivity and weight of the electroconductive filler (b2), and the elasticity and flexibility of the produced electroconductive protective layer.

(b3) Other Components

Other components may be incorporated on an optional basis as appropriate in addition to the fluororesin (b1) and the electroconductive filler (b2).

These other components can be exemplified by the following: (b3-1) finely divided rubber particles in order to provide flexibility; (b3-2) an adhesive in order to improve the adherence between the current collector and the electroconductive layer; (b3-3) a coupling agent or crosslinking agent in order to reduce the swellability of the fluororesin; and (b3-4) a surfactant to improve the dispersibility of the electroconductive filler and improve the levelling performance of the coating.

The finely divided rubber particles (b3-1) are preferably particles of a fluororubber or a fluorine-free rubber and more preferably are crosslinked rubber particles. The fluororubber can be exemplified by VdF-type copolymer elastomers and TFE-type copolymer elastomers. The fluorine-free rubber can be exemplified by acrylic rubbers, SBR rubbers, HNBR rubbers, and nitrile rubbers.

The adhesive (b3-2) can be exemplified by epoxy resins, phenolic resins, silane coupling agents, and urethane resins.

The coupling agent or crosslinking agent (b3-3) can be exemplified by silane coupling agents and urethane-type crosslinking agents.

The surfactant (b3-4) can be exemplified by anionic, nonionic, and cationic surfactants.

The electroconductive protective layer (B) of the present invention is formed by application to the positive electrode current collector (A) of a protective layer-forming composition that contains the fluororesin (b1), the electroconductive filler (b2), and the optional other component (b3).

The protective layer-forming composition may be a coating composition or may be a molding composition.

In the case of a coating composition, a solvent (b4) is incorporated in addition to the fluororesin (b1), electroconductive filler (b2), and optional other component (b3). This solvent (b4) may be an organic solvent or may be a water-based solvent.

The organic solvent can be exemplified by polar solvents such as ketones, e.g., methyl ethyl ketone, acetone, cyclohexanone, and dibutyl ketone; amides, e.g., N-methylpyrrolidone, dimethylacetamide, and dimethylformamide; esters, e.g., butyl acetate, amyl acetate, butyl propionate, ethyl cellosolve, and methyl cellosolve; and ethers, e.g., tetrahydrofuran, diglyme, and triglyme.

The water-based solvent is typically water, which may be used in combination with, for example, an alcohol or ketone. In this case, the coating composition takes the form of an emulsion.

The blending proportions for the fluororesin (b1) and electroconductive filler (b2) in a coating composition are the proportions described above in connection with the protective layer. The amount of the solvent (b4) may be the amount that provides a concentration suitable for the coating operation.

The coating composition can be prepared by mixing the individual components using an ordinary mixing method as used for resin-based coating compositions.

The method for forming the coating film may be a heretofore known method. For example, the coating film may be formed by application to the substrate using, for example, a roller coating method, brush coating method, dip coating method, spray coating method, gravure coating method, coil coating method, or curtain flow coating method, with natural drying at the ambient temperature or drying with the application of heat.

When the protective layer-forming composition is implemented in the form of a molding composition, the fluororesin (b1), electroconductive filler (b2), optional other component (b3), and solvent (b4) may be slurried using the usual methods.

The volume resistivity of the electroconductive protective layer (B) obtained as described above can be controlled in the range from 0.001 to 50 Ω.cm, and as necessary a strongly electroconductive protective layer, i.e., from 0.001 to 10 Ω.cm and particularly 1 Ω.cm or less, can be provided.

The thickness of the electroconductive protective layer (B) may be selected as appropriate from the range of 0.1 to 50 μm and, for example, is at least 0.5 μm and preferably at least 1.0 μm from the standpoint of obtaining a low resistance and is not more than 50 μm and preferably not more than 10 μm from the standpoint of electrode fabrication.

The current collector laminate of the present invention exhibits a substantial effect when used for the positive electrode, which is subject to substantial corrosion of the current collector. However, a current collector with the structure according to the present invention may also be used for the negative electrode current collector.

The present invention also relates to a positive electrode laminate in which a positive electrode mixture layer (C) is disposed on the electroconductive protective layer (B) of the positive electrode current collector laminate of the present invention.

The positive electrode mixture that forms the positive electrode mixture layer (C) includes a positive electrode active material and a binder and as necessary is prepared with the incorporation of other materials. The heretofore known positive electrode mixtures can be used with the present invention, but positive electrode mixtures for high voltage operations are particularly effective for the present invention.

The positive electrode active material is particularly preferably a lithium-containing transition metal composite oxide that is capable of generating a high voltage; for example, a lithium-manganese spinel composite oxide with formula (2): LiₐMn_{2-b}M¹_{b}O₄ (in the formula, 0.9≦a; 0≦b≦1.5; and M¹ is at least one metal selected from the group consisting of Fe, Co, Ni, Cu, Zn, Al, Sn, Cr, V, Ti, Mg, Ca, Sr, B, Ga, In, Si, and Ge), a lithium-nickel composite oxide with formula (3) : LiNi_{1-c}M²_{c}O₂ (in the formula, 0≦c≦0.5 and M² is at least one metal selected from the group consisting of Fe, Co, Mn, Cu, Zn, Al, Sn, Cr, V, Ti, Mg, Ca, Sr, B, Ga, In, Si, and Ge), and a lithium-cobalt composite oxide represented by LiCo_{1-d}M³_{d}O₂ (in the formula, 0≦d≦0.5 and M³ is at least one metal selected from the group consisting of Fe, Ni, Mn, Cu, Zn, Al, Sn, Cr, V, Ti, Mg, Ca, Sr, B, Ga, In, Si, and Ge) are preferred.

LiCoO₂, LiMnO₂, LiNiO₂, LiMn₂O₄, LiNi_{0.8}Co_{0.15}Al_{0.05}O₂, or LiNi_{1/3}Co_{1/3}Mn_{1/3}O₂ is specifically preferred among the preceding because they can provide a high-output lithium secondary battery with a high energy density.

Besides the preceding, the positive electrode active material may also be, for example, LiFePO₄, LiNi_{0.8}Co_{0.2}O₂, Li_{1.2}Fe_{0.4}Mn_{0.4}O₂, LiNi_{0.5}Mn_{0.5}O₂, or LiV₃O₆.

The quantity of incorporation for the positive electrode active material is preferably 50 to 99 mass % and more preferably 80 to 99 mass % of the positive electrode mixture from the standpoint of obtaining a high battery capacity.

The binder can be exemplified by fluororesins, fluorine-free resins, and rubbers.

The fluororesins can be exemplified by polytetrafluoroethylene (PTFE) and polyvinylidene fluoride (PVdF). The PTFE may be a homopolymer of tetrafluoroethylene or may be a modified PTFE as afforded by the copolymerization of a small amount of another monomer such as HFP or PAVE.

The fluorine-free resins can be exemplified by polyacrylic acids. The rubbers can be exemplified by ethylene/propylene/diene copolymer rubbers (EPDM) and styrene/butadiene copolymer rubbers (SBR).

The quantity of incorporation for the binder is preferably 0.5 to 15 mass % and more preferably 0.5 to 10 mass % of the positive electrode mixture from the standpoint of obtaining a high battery capacity.

Other components can be exemplified by fluororesins, such as TFE/HFP copolymer resins, ETFE, and VdF-type copolymer resins, for the purpose of improving the adhesiveness of the positive electrode mixture and/or improving the availability of the positive electrode active material; fluororubbers and acrylic rubbers, for the purpose of improving the flexibility; cellulosic resins, e.g., cellulose acetate, for the purpose of improving the withstand voltage; as well as the additives used in the fabrication of lithium secondary battery electrodes, for example, electroconductive materials, thickeners, other polymers, and surfactants for electrode fabrication. The electroconductive material can be exemplified by electroconductive carbon blacks such as acetylene black and Ketjenblack; and carbonaceous materials such as graphite and carbon fiber.

The positive electrode mixture layer (C) can be formed by a method in which a positive electrode mixture-forming composition is prepared by mixing the previously described components as appropriate, possibly using a suitable solvent, to obtain a uniform mixture, and coating this by, e.g., spin coating, blade coating, roll coating, dip coating, and so forth, on the electroconductive protective layer (B) of the positive electrode current collector laminate.

The dried electrode is typically subjected to a press-rolling treatment as necessary and then cut and processed to the desired thickness and dimensions to yield the positive electrode for lithium secondary battery. The press-rolling treatment and cutting operation may be carried out by the usual methods.

Since the positive electrode current collector (A) in the positive electrode laminate of the present invention is protected by the electroconductive protective layer (B) from the lithium salt in the electrolyte solution, corrosion of the current collector can be inhibited even at high operating voltages and the deterioration in battery characteristics, e.g., the cycle characteristics, can be restrained. In combination with this, the electrode flexibility is also improved with the positive electrode laminate of the present invention and as a consequence cracking and debonding do not occur even during winding as in a wound-type lithium secondary battery.

The present invention also relates to a lithium secondary battery. The lithium secondary battery of the present invention is provided with a positive electrode, a negative electrode, and a nonaqueous electrolyte solution and uses the positive electrode laminate of the present invention for its positive electrode. A current collector with the structure according to the present invention may also be used for the negative electrode current collector.

A heretofore known electrode can be used for the negative electrode when an electrode having a structure other than that of the positive electrode current collector laminate of the present invention is used for the negative electrode.

The nonaqueous electrolyte solution is an electrolyte solution that contains an electrolyte salt and an organic solvent for dissolution of the electrolyte salt, and any nonaqueous electrolyte solutions used in lithium secondary batteries can be used without particular limitation.

The electrolyte can be exemplified by known electrolyte salts, for example, LiPF₆, LiBF₄, LiN(SO₂CF₃)₂, and LiN(SO₂C₂F₅)₂. The organic solvent can be exemplified by hydrocarbon-type solvents such as ethylene carbonate, dimethyl carbonate, methyl ethyl carbonate, diethyl carbonate, and propylene carbonate; fluorinated solvents such as HCF₂CF₂CH₂OCF₂CF₂H, CF₃COOCF₃, and CF₃COOCH₂CF₃; and mixed solvents of the preceding; however, the electrolyte salt and the organic solvent are not limited to just the preceding.

The negative electrode active material constituting the negative electrode can be exemplified by carbonaceous materials and also by metal oxides and metal nitrides capable of incorporating the lithium ion. The carbonaceous material can be exemplified by natural graphite, artificial graphite, pyrolyzed carbons, cokes, mesocarbon microbeads, carbon fibers, active carbon, and pitch-coated graphite. Metal oxides capable of incorporating the lithium ion can be exemplified by metal compounds that contain tin, silicon, or titanium, for example, tin oxide, silicon oxide, and lithium titanate. Metal nitrides capable of incorporating the lithium ion can be exemplified by Li_{2.6}Co_{0.4}N.

The quantity of incorporation for the negative electrode active material is preferably 50 to 99 mass % and more preferably 80 to 99 mass % of the negative electrode mixture from the standpoint of obtaining a high battery capacity.

A separator may be disposed in the lithium secondary battery of the present invention. There are no particular limitations on the separator, and the separator can be exemplified by microporous polyethylene film, microporous polypropylene film, microporous ethylene-propylene copolymer film, microporous polypropylene/polyethylene bilayer film, and microporous polypropylene/polyethylene/polypropylene trilayer film. With the goal of improving the safety with regard to, e.g., short circuiting caused by Li dendrites, the separator can be exemplified by a film provided by coating the separator with an aramid resin and a film provided by coating the separator with a polyamideimide- and alumina filler-containing resin (refer, for example, to Japanese Patent Application Laid-open Nos. 2007-299612 and 2007-324073).

The lithium secondary battery of the present invention is useful as a large-scale lithium secondary battery for hybrid vehicles and for service as a distributed or decentralized power source and is also useful as a small-scale lithium secondary battery for portable phones, personal digital assistants, and so forth.

### EXAMPLES

The present invention is described herebelow using examples, but the present invention is not limited to just these examples.

The measurement and evaluation methods used in the present invention are described below.

(The Volume Resistivity)

The volume resistivity is measured by the following method. The volume resistivity is measured on the laminate; however, since the volume resistivity of the current collector is negligible in comparison to the volume resistivity of the electroconductive protective layer, the volume resistivity value of the laminate is considered to be equivalent to the volume resistivity of the electroconductive protective layer.

(1) Measurement on the Laminate.

A thickness 2.2 mm×width 26 mm×length 60 mm sample is fabricated and its volume resistivity is measured in accordance with JIS K 7194. With regard to the measurement instrumentation, the volume resistivity is measured by the four probe method using a LorestaMP (product name: MCP-T350) from Mitsubishi Chemical Corporation.

(Measurement of the Film Thickness)

This measurement is performed using a Quick Micro MDQ-30M from Mitutoyo Corporation.

### Example 1

A composition with the composition given below was prepared using a planetary mill and was coated on aluminum foil (thickness: 15 μm) using a bar coater to obtain a laminate in which an electroconductive protective layer (thickness: 5.8 μm) was formed on the aluminum foil.

(b1) fluororesin: 100 mass parts

(b2) electroconductive filler: 100 mass parts

(b4) organic solvent: 800 mass parts

Each of these components is defined below.

(b1-1) The fluororesin:

composition: PVdF

weight-average molecular weight (Mw): 110,000

(b2-1) The electroconductive filler:

type: electroconductive graphite (HAG artificial graphite from Nippon Graphite Industries, Ltd.)

average particle diameter: 5 μm

volume resistivity: 0.05 Ω.cm

(b4-1) The organic solvent: N-methylpyrrolidone (NMP)

The volume resistivity of the obtained laminate was determined. The result is shown in Table 1.

### Example 2

Proceeding as in Example 1, a paint was prepared, but in this case changing the quantity of incorporation of the electroconductive filler used in Example 1 to 150 mass parts, and a laminate was obtained in which an electroconductive protective layer (thickness: 6 μm) was formed on the aluminum foil.

The volume resistivity of the obtained laminate was determined. The result is shown in Table 1.

The electroconductivity level (0.09 Ω.cm) obtained in this example is in the region designated for a high-electroconductivity material, and the laminate obtained in this example was also possible to combine this property with an excellent processability. This laminate could be used as an electrode and as a heater because heat generation is observed when voltage is applied to this laminate.

### Example 3

Proceeding as in Example 1, a paint was prepared, but in this case using the following fluororesin (b1-2) for the fluororesin (b1) in Example 1, and a laminate was obtained in which an electroconductive protective layer (thickness: 6 μm) was formed on the aluminum foil.

(b1-2) The fluororesin:

composition: TFE/VdF/HFP=37/60.5/2.5 (molar ratio) weight-average molecular weight (Mw): 170,000

The volume resistivity of the obtained laminate was determined. The result is shown in Table 1.

### Example 4

Proceeding as in Example 3, a paint was prepared, but in this case changing the quantity of incorporation of the electroconductive filler used in Example 3 to 150 mass parts, and a laminate was obtained in which an electroconductive protective layer (thickness: 6 μm) was formed on the aluminum foil.

The volume resistivity of the obtained laminate was determined. The result is shown in Table 1.

Example 5

Proceeding as in Example 1, a paint was prepared, but in this case using the following electroconductive filler (b2-2) for the electroconductive filler in Example 1, and a laminate was obtained in which an electroconductive protective layer (thickness: 8 μm) was formed on the aluminum foil.

(b2-2) The electroconductive filler:

type: electroconductive carbon fiber (KRECA KCF100 from Kureha Chemical Industry Co., Ltd.)

average fiber diameter: 10 μm

volume resistivity: 0.015 Ω.cm

The volume resistivity of the obtained laminate was determined. The result is shown in Table 1.

### Example 6

Proceeding as in Example 5, a paint was prepared, but in this case changing the quantity of incorporation of the electroconductive filler used in Example 5 to 150 mass parts, and a laminate was obtained in which an electroconductive protective layer (thickness: 8 μm) was formed on the aluminum foil.

The volume resistivity of the obtained laminate was determined. The result is shown in Table 1.

### Example 7

Proceeding as in Example 5, a paint was prepared, but in this case using the (b1-2) used in Example 3 for the fluororesin (b1) used in Example 5, and a laminate was obtained in which an electroconductive protective layer (thickness: 8 μm) was formed on the aluminum foil.

The volume resistivity of the obtained laminate was determined. The result is shown in Table 1.

### Example 8

Proceeding as in Example 1, a paint was prepared, but in this case using, for the electroconductive filler used in Example 1, the combination of 50 mass parts of the electroconductive graphite (b2-1) used in Example 1 and 50 mass parts of the electroconductive carbon fiber (b2-2) used in Example 5, and a laminate was obtained in which an electroconductive protective layer (thickness: 8 μm) was formed on the aluminum foil.

The volume resistivity of the obtained laminate was determined. The result is shown in Table 1.

### Example 9

Proceeding as in Example 1, a paint was prepared, but in this case changing the quantity of incorporation of the electroconductive filler used in Example 1 to 60 mass parts, and a laminate was obtained in which an electroconductive protective layer (thickness: 8 μm) was formed on the aluminum foil.

The volume resistivity of the obtained laminate was determined. The result is shown in Table 1.

### Comparative Example 1

Proceeding as in Example 5, a paint was prepared, but in this case using an equal amount of MT carbon (Thermax N990 from Cancarb Ltd.) in place of the electroconductive filler used in Example 5, and a laminate was obtained in which an electroconductive protective layer (thickness: 5 μm) was formed on the aluminum foil.

The volume resistivity of the obtained laminate was determined. The result is shown in Table 1.

### Comparative Example 2

Proceeding as in Example 7, a paint was prepared, but in this case using an equal amount of MT carbon (Thermax N990 from Cancarb Ltd.) in place of the electroconductive filler used in Example 7, and a laminate was obtained in which an electroconductive protective layer (thickness: 5 μm) was formed on the aluminum foil.

The volume resistivity of the obtained laminate was determined. The result is shown in Table 1.

TABLE 1

| | | | | | | | | | | Comparative | |
|---|---|---|---|---|---|---|---|---|---|---|---|
| | Example | | | | | | | | | Example | |
| | 1 | 2 | 3 | 4 | 5 | 6 | 7 | 8 | 9 | 1 | 2 |
| Fluororesin (b1) | | | | | | | | | | | |
| b1-1 | 100 | 100 | — | — | 100 | 100 | — | 100 | 100 | 100 | — |
| b1-2 | — | — | 100 | 100 | — | — | 100 | — | — | — | 100 |
| Electroconductive filler (b2) | | | | | | | | | | | |
| b2-1 | 100 | 150 | 100 | 150 | — | — | — | 50 | 60 | — | — |
| b2-2 | — | — | — | — | 100 | 150 | 100 | 50 | — | — | — |
| MT carbon | — | — | — | — | — | — | — | — | — | 100 | 100 |
| Volume resistivity (Ω · cm) | 0.4 | 0.1 | 2.1 | 0.7 | 19.5 | 0.8 | 41.0 | 4.2 | 10.3 | 52.0 | 49.0 |

### Example 10

Proceeding as in Example 5, a paint was prepared, but in this case using the following electroconductive filler (b2-3) for the electroconductive filler in Example 5, and a laminate was obtained in which an electroconductive protective layer (thickness: 5 μm) was formed on the aluminum foil.

(b2-3) The electroconductive filler:

type: electroconductive graphite (HOP amorphous graphite from Nippon Graphite Industries, Ltd.)

average particle diameter: 4 μm

volume resistivity: 0.002 Ω.cm

The volume resistivity of the obtained laminate was determined. The result is shown in Table 2.

### Example 11

Proceeding as in Example 10, a paint was prepared, but in this case changing the quantity of incorporation of the electroconductive filler used in Example 10 to 60 mass parts, and a laminate was obtained in which an electroconductive protective layer (thickness: 5 μm) was formed on the aluminum foil.

The volume resistivity of the obtained laminate was determined. The result is shown in Table 2.

### Example 12

Proceeding as in Example 5, a paint was prepared, but in this case using the following electroconductive filler (b2-4) for the electroconductive filler in Example 5, and a laminate was obtained in which an electroconductive protective layer (thickness: 1.4 μm) was formed on the aluminum foil.

(b2-4) The electroconductive filler:

type: electroconductive graphite (JB-5 flake graphite from Nippon Graphite Industries, Ltd.)

average particle diameter: 8 μm

volume resistivity: 0.0003 Ω.cm

The volume resistivity of the obtained laminate was determined. The result is shown in Table 2.

### Example 13

Proceeding as in Example 12, a paint was prepared, but in this case changing the quantity of incorporation of the electroconductive filler used in Example 12 to 60 mass parts, and a laminate was obtained in which an electroconductive protective layer (thickness: 4 μm) was formed on the aluminum foil.

The volume resistivity of the obtained laminate was determined. The result is shown in Table 2.

### Example 14

Proceeding as in Example 5, a paint was prepared, but in this case using the following electroconductive filler (b2-5) for the electroconductive filler in Example 5 and changing its quantity of incorporation to 20 mass parts, and a laminate was obtained in which an electroconductive protective layer (thickness: 2.8 μm) was formed on the aluminum foil.

(b2-5) The electroconductive filler:

type: Ketjenblack (ECP-600JD from the Lion Corporation)

average particle diameter: 40 nm

volume resistivity: 0.1 Ω.cm

The volume resistivity of the obtained laminate was determined. The result is shown in Table 2.

### Example 15

Proceeding as in Example 5, a paint was prepared, but in this case using the following electroconductive filler (b2-6) for the electroconductive filler in Example 5 and changing its quantity of incorporation to 20 mass parts, and a laminate was obtained in which an electroconductive protective layer (thickness: 1.4 μm) was formed on the aluminum foil.

(b2-6) The electroconductive filler:

type: acetylene black (Denka Black from Denki Kagaku Kogyo Kabushiki Kaisha)

average particle diameter: 35 nm

volume resistivity: 0.2 Ω.cm

The volume resistivity of the obtained laminate was determined. The result is shown in Table 2.

### Example 16

Proceeding as in Example 15, a paint was prepared, but in this case changing the quantity of incorporation of the electroconductive filler used in Example 15 to 60 mass parts, and a laminate was obtained in which an electroconductive protective layer (thickness: 2.0 μm) was formed on the aluminum foil.

The volume resistivity of the obtained laminate was determined. The result is shown in Table 2.

### Example 17

Proceeding as in Example 5, a paint was prepared, but in this case using the following electroconductive filler (b2-7) for the electroconductive filler in Example 5 and changing its quantity of incorporation to 60 mass parts, and a laminate was obtained in which an electroconductive protective layer (thickness: 0.3 μm) was formed on the aluminum foil.

(b2-7) The electroconductive filler:

type: electroconductive nanoporous carbon (nanoporous carbon from Easy-N, Inc.)

average particle diameter: 35 nm

volume resistivity: 0.1 Ω.cm

The volume resistivity of the obtained laminate was determined. The result is shown in Table 2.

TABLE 2

| | Example | | | | | | | |
|---|---|---|---|---|---|---|---|---|
| | 10 | 11 | 12 | 13 | 14 | 15 | 16 | 17 |
| Fluororesin | | | | | | | | |
| (b1) | | | | | | | | |
| b1-1 | 100 | 100 | 100 | 100 | 100 | 100 | 100 | 100 |
| Electro- | | | | | | | | |
| conductive | | | | | | | | |
| filler (b2) | | | | | | | | |
| b2-3 | 100 | 60 | — | — | — | — | — | — |
| b2-4 | — | — | 100 | 60 | — | — | — | — |
| b2-5 | — | — | — | — | 20 | — | — | — |
| b2-6 | — | — | — | — | — | 20 | 60 | — |
| b2-7 | — | — | — | — | — | — | — | 60 |
| Volume | 0.4 | 0.5 | 0.1 | 3.5 | 0.3 | 20.1 | 1.0 | 8.0 |
| resistivity | | | | | | | | |
| (Ω · cm) | | | | | | | | |

### Example 18

Proceeding as in Example 16, a paint was prepared, but in this case changing the fluororesin to fluororesin (b1-2), and a laminate was obtained in which an electroconductive protective layer (thickness: 2.0 μm) was formed on the aluminum foil.

The volume resistivity of the obtained laminate was determined. The result is shown in Table 3.

### Example 19

Proceeding as in Example 16, a paint was prepared, but in this case changing the fluororesin to the following fluororesin (b1-3), and a laminate was obtained in which an electroconductive protective layer (thickness: 2.3 μm) was formed on the aluminum foil.

(b1-3) The fluororesin:

composition: VdF/TFE=80/20 (molar ratio)

weight-average molecular weight (Mw): 170,000

The volume resistivity of the obtained laminate was determined. The result is shown in Table 3.

### Example 20

Proceeding as in Example 16, a paint was prepared, but in this case changing the fluororesin to the following fluororesin (b1-4), and a laminate was obtained in which an electroconductive protective layer (thickness: 2.7 μm) was formed on the aluminum foil.

(b1-4) The fluororesin:

composition: VdF/TFE=88/12 (molar ratio)

weight-average molecular weight (Mw): 150,000

The volume resistivity of the obtained laminate was determined. The result is shown in Table 3.

### Example 21

Proceeding as in Example 18, a paint was prepared, but in this case adding 0.5 mass part tetraethoxysilane (b3-1) as an additive (b3), and a laminate was obtained in which an electroconductive protective layer (thickness: 2.1 μm) was formed on the aluminum foil.

The volume resistivity of the obtained laminate was determined. The result is shown in Table 3.

### Example 22

Proceeding as in Example 18, a paint was prepared, but in this case adding 5 mass parts finely divided acrylic rubber particles (b3-2) as an additive (b3), and a laminate was obtained in which an electroconductive protective layer (thickness: 2.1 μm) was formed on the

The volume resistivity of the obtained laminate was determined. The result is shown in Table 3.

TABLE 3

| | Example | | | | |
|---|---|---|---|---|---|
| | 18 | 19 | 20 | 21 | 22 |
| Fluororesin (b1) | | | | | |
| b1-2 | 100 | — | — | 100 | 100 |
| b1-3 | — | 100 | — | — | — |
| b1-4 | — | — | 100 | — | — |
| Electroconductive | | | | | |
| filler (b2) | | | | | |
| b2-6 | 60 | 60 | 60 | 60 | 60 |
| Additive (b3) | | | | | |
| b3-1 | — | — | — | 0.5 | — |
| b3-2 | — | — | — | — | 5 |
| Volume resistivity | 0.9 | 1.2 | 0.8 | 0.8 | 1.3 |
| (Ω · cm) | | | | | |

### Example 23

Proceeding as in Example 16, a paint was prepared, but in this case changing the fluororesin to the following fluororesin (b1-5), and a laminate was obtained in which an electroconductive protective layer (thickness: 2.7 μm) was formed on the aluminum foil.

(b1-5) The fluororesin:

composition: VdF/TFE=67/33 (molar ratio)

weight-average molecular weight (Mw): 200,000

The volume resistivity of the obtained laminate was determined. The volume resistivity was 1.0 Ω.cm.

Example 24

Proceeding as in Example 16, a paint was prepared, but in this case changing the fluororesin to the following fluororesin (b1-6), and a laminate was obtained in which an electroconductive protective layer (thickness: 2.7 μm) was formed on the aluminum foil.

(b1-6) The fluororesin:

composition: VdF/HFP=92/8 (molar ratio)

weight-average molecular weight (Mw): 200,000

The volume resistivity of the obtained laminate was determined. The volume resistivity was 0.9 Ω.cm.

### Example 25

(Fabrication of a Laminate Cell)

A positive electrode active material was prepared by mixing _{LiNi}_{0.33}Co_{0.33}Al_{0.33}O₂, carbon black, and polyvinylidene fluoride (product name: KF-1000, from Kureha Chemical Industry Co., Ltd.) at 90/3/7 (mass % ratio). A positive electrode mixture layer-forming composition was prepared by dispersing this positive electrode active material in N-methyl-2-pyrrolidone to give a slurry and was uniformly coated on the laminate (positive electrode current collector) fabricated according to Example 1 and having an electroconductive protective layer formed on aluminum foil (foil thickness=15 μm). Drying then yielded a positive electrode mixture layer formed on the electroconductive protective layer. This was followed by compression molding using a roller press, cutting, and lead element connection to give a strip-form positive electrode.

Separately, styrene-butadiene rubber dispersed in distilled water was added to an artificial graphite powder (product name: MAG-D, from Hitachi Chemical Co., Ltd.) to provide a solids fraction of 6 mass %, and this was mixed with a disperser to yield a slurry. This slurry was uniformly coated on a negative electrode current collector (copper foil with a thickness of 10 μm) and then dried to form a negative electrode mixture layer. This was followed by compression molding with a roller press, cutting, then drying and lead element connection to yield a strip-form negative electrode.

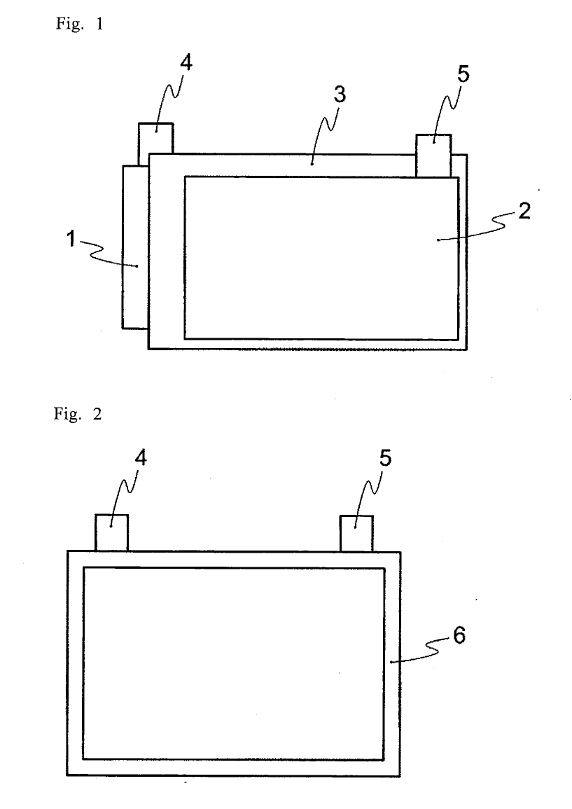

As shown in the schematic structural diagram in perspective view in FIG. 1, the strip-form positive electrode 1 was cut to 40 mm×72 mm (with attached 10 mm×10 mm positive electrode terminal 4); the strip-form negative electrode 2 was cut to 42 mm×74 mm (with attached 10 mm×10 mm negative electrode terminal 5); and lead elements were attached to each terminal. A 20 μm-thick microporous polyethylene film was cut to a size of 78 mm×46 mm to provide a separator 3; the positive electrode and negative electrode were assembled so as to sandwich the separator 3; these were inserted into an aluminum laminate package 6 as shown in FIG. 2; 2 mL of an electrolyte solution was subsequently introduced into the package 6; and sealing then yielded a laminate cell with a capacity of 72 mAh. The electrolyte solution used was prepared by dissolving LiPF₆ to a concentration of 1 mole/liter in a mixed solvent of ethylene carbonate (EC) and ethyl methyl carbonate (EMC).

Cycle characteristic 1 was examined using the procedure indicated below and using the fabricated laminate cell.

(Cycle Characteristic 1)

With regard to charge-discharge, and letting 1 cycle be a cycle of charging at 1.0 C and at 4.3 V until the charging current reaches 1/10 C, discharging to 3.0 V at a current corresponding to 0.2 C, and charging at 1.0 C and at 4.3 V until the charging current reaches 1/10 C, cycle characteristic 1 is the capacity retention rate (%) at the 50th cycle with reference to the fifth cycle.

The resulting cycle characteristic was an excellent 88%. On the other hand, this cycle characteristic was 81% for a comparative laminate cell that was fabricated in the same manner but without using the electroconductive protective layer.

### Example 26

A cycle characteristic 2 was examined as in Example 25, but altering the measurement conditions in cycle characteristic 1 as indicated below.

(Cycle Characteristic 2)

With regard to charge-discharge, and letting 1 cycle be a cycle of charging at 1.0 C and at 4.4 V until the charging current reaches 1/10 C, discharging to 3.0 V at a current corresponding to 0.2 C, and charging at 1.0 C and at 4.3 V until the charging current reaches 1/10 C, cycle characteristic 2 is the capacity retention rate (%) at the 50th cycle with reference to the fifth cycle.

The resulting cycle characteristic 2 was an excellent 84%. On the other hand, this cycle characteristic 2 was 72% for a comparative laminate cell that was fabricated in the same manner but without using the electroconductive protective layer.

### Example 27

A laminate cell was fabricated as in Example 25, but in this case using EC/EMC/HCF₂CF₂CH₂OCF₂CF₂H (volumetric ratio: 20/60/20) for the electrolyte solution used, and cycle characteristic 2 was examined.

The resulting cycle characteristic 2 was a high 95%. On the other hand, this cycle characteristic 2 was 88% for a comparative laminate cell that was fabricated in the same manner but without using the electroconductive protective layer.

An improvement in the cycle characteristic due to the disposition of the electroconductive protective layer was thus seen, and this is thought to be due to an inhibition of corrosion of the aluminum.

### Example 28

Using for the working electrode a positive electrode current collector fabricated according to Examples 1 to 24, in which an electroconductive protective layer was disposed on aluminum foil, and using lithium for the counter and reference electrodes, a CV electrode was fabricated by cutting the working electrode to a size of 0.5×0.7 cm and welding a nickel wire by resistance welding. The electrolyte solution used for the measurement was an electrolyte solution prepared by adding LiPF₆ as the electrolyte salt to a concentration of 1.0 mole/liter to a solvent for electrolyte salt dissolution in the form of ethylene carbonate (EC)/methyl ethyl carbonate (MEC) (=30/70 volume %).

A measurement cell was constructed using a sealed voltammetric cell (VC-4) from BAS; installing a CV electrode fabricated as described above for the working electrode; using Li for the counter electrode and the reference electrode; and introducing 3 mL of the previously described electrolyte solution. Using a potentio/galvanostat (Model 1287 from Solartron), this measurement cell was scanned at 5 mV/sec from 3 V to 10 V at 25° C. (constant); the current change was measured in order to measure the voltage at which 0.5 mA/cm² was reached.

Since the limit value for the withstand voltage of the aforementioned electrolyte solution is about 5.5 V, the evaluation was carried out by determining whether the measurement voltage reached at least 5.5 V.

According to the results, the measurement voltage was at least 5.5 V for all the electrodes according to the examples. The limit voltage was 4.5 V when a current collector composed of only aluminum foil was used as the working electrode.

It could be confirmed from these results that corrosion of the aluminum was inhibited by the disposition of the electroconductive protective layer.

### EXPLANATION OF THE REFERENCE NUMERALS

1 positive electrode

2 negative electrode

3 separator

4 positive electrode terminal

5 negative electrode terminal

6 aluminum laminate package

1. A positive electrode current collector laminate, comprising an electroconductive protective layer (B) that contains a fluororesin (b1) and an electroconductive filler (b2) and is disposed on a positive electrode current collector (A),
wherein the fluororesin (b1) is a copolymer containing tetrafluoroethylene and vinylidene fluoride.

2.-3. (canceled)

4. The positive electrode current collector laminate according to claim 1, wherein the electroconductive filler (b2) is a particulate filler, a fibrous filler, or a combination thereof.

5. The positive electrode current collector laminate according to claim 1, wherein the electroconductive filler (b2) is an electroconductive carbon filler.

6. The positive electrode current collector laminate according to claim 1, wherein a volume resistivity of the electroconductive protective layer (B) is from 0.001 to 50 Ω.cm.

7. The positive electrode current collector laminate according to claim 1, that contains 5 to 300 mass parts of the electroconductive filler (b2) per 100 mass parts of the fluororesin (b1).

8. The positive electrode current collector laminate according to claim 1, wherein the electroconductive protective layer (B) is formed by the application of a fluororesin coating composition containing the fluororesin (b1) and the electroconductive filler (b2).

9. A positive electrode laminate, comprising a positive electrode mixture layer (C) disposed on an electroconductive protective layer (B) of the current collector laminate according to claim 1.

10. A lithium secondary battery, comprising: a positive electrode; a negative electrode; and a nonaqueous electrolyte solution, wherein the positive electrode is the positive electrode laminate according to claim 9.
